(19) United States
(12) Patent Application Publication
(10) Pub. No.: US 2024/0107089 A1
(43) Pub. Date: Mar. 28, 2024

(54) SERVER, METHOD FOR PROCESSING A VIDEO BY MEANS OF THE SERVER, TERMINAL AND METHOD USED BY THE TERMINAL TO AUGMENT THE VIDEO BY MEANS OF AN OBJECT

(71) Applicant: Orange, Issy-les-Moulineaux (FR)

(72) Inventors: Chantal Guionnet, Châtillon Cedex (FR); Richard Guignon, Châtillon Cedex (FR); Jeremy Lacoche, Châtillon Cedex (FR)

(21) Appl. No.: 18/257,424

(22) PCT Filed: Dec. 13, 2021
(86) PCT No.: PCT/FR2021/052289

§ 371 Date: Jun. 14, 2023

(30) Foreign Application Priority Data
Dec. 15, 2020 (FR) 2013226

(51) Int. Cl. H04N 21/236; H04N 21/2187

(52) U.S. Cl. CPC H04N 21/23614; H04N 21/2187

(57) ABSTRACT

A terminal includes an object adapter for augmenting an initial video which includes a succession of images acquired by a camera. The adapter is capable of adapting, at least in images following a first image of the initial video received by the terminal, at least one characteristic for viewing the augmentation object, which characteristic is selected and inserted into the first image. The adapter is capable of operating according to parameters of the camera, such as position and calibration parameters of the camera, which are associated with the images of the initial video, the parameters having been received by the terminal in association with the initial video.

### PRIOR ART

The invention relates to the general field of the enrichment of a video by a user, in a customized manner.

In the current state of the art, techniques are known for enriching videos by insertion of objects called enrichment objects, for example text, a two-dimensional or three-dimensional image or another video, before it is broadcast to users.

This solution does not allow customized enrichment of the video by the end users, that is to say by insertion of enrichment objects chosen by the users.

To date, there is no solution allowing a user to easily insert objects into a video received via a telecommunications network, which offers a satisfactory rendering from the user's point of view.

### DISCLOSURE OF THE INVENTION

The invention relates to a method for processing a video for broadcast. The video, called initial video, includes a succession of images acquired by a camera. The method is implemented by a server and comprises at least one step of generating an enriched stream, the enriched stream being composed of the initial video and, for at least one image of the initial video, of parameters of the position and calibration of the camera associated with this image, the initial video and said parameters being able to be emitted to at least one terminal.

Correlatively, the invention relates to a server configured to process a video for broadcast, the video, called initial video, including a succession of images acquired by a camera, the server comprising an enriched stream generator, the enriched stream being composed of the initial video and, for at least one image of the initial video, of parameters of the position and calibration of the camera associated with this image, the initial video and said parameters being able to be emitted to at least one terminal.

The characteristics and advantages of the video processing method according to the invention presented below apply in the same way to the server according to the invention and vice versa.

The server and the terminals receiving the video and the parameters communicate with each other via a communication network, for example an IP network. No limitation is imposed on the nature of this communication network. The proposed server can send the initial video and the parameters of the camera to one or more identified terminals, for example in the context of point-to-point or point-to-multipoint communication. Alternatively, the server can send the initial video and the parameters of the camera in broadcast mode, without identifying a specific destination terminal.

The camera can be connected to the server via a wired or wireless connection, via a local or wide area network.

The parameters of the position of the camera are the coordinates of the lens of the camera in a Cartesian coordinate system, for example an orthonormal or a spherical coordinate system.

The parameters of the calibration of the camera can comprise at least one coordinate of the optical center of the camera (in the aforementioned Cartesian coordinate system or in another coordinate system), a focal length, a magnification factor and/or distortion parameters.

The proposed server can obtain the parameters of the camera from different sensors associated with or included in the camera, for example a coordinate sensor of the camera along a given axis, or a module for determining the focal length of the camera, or a module for determining a magnification factor. Particularly, the proposed server can obtain these parameters continuously, as the initial video is acquired by the camera or as the initial video is received by the server.

The server and the processing method proposed make it possible to provide the terminals that receive the initial video and the parameters of the camera, means for enriching the video in a customized manner and obtaining a natural rendering thanks to the consideration of the parameters of the camera by the terminals for the positioning of the objects in the initial video. Particularly, the server can send the enriched stream to the terminals, the parameters of the position and calibration of the camera being integrated into the broadcast enriched stream.

It is meant by parameter of the camera associated with an image, the parameter of the camera at the time of the acquisition of the image by the camera.

The invention also relates to a method for enriching a video, called initial video, with at least one enrichment object, the initial video comprising a succession of images acquired by a camera, the method being implemented by a terminal and comprising at least one step of adapting, at least in images following a first image of the initial video received by the terminal, viewing characteristics for an enrichment object selected and inserted into the first image, the adaptation being performed as a function of parameters of the position and calibration of the camera associated with the images of the initial video, the parameters having been received by the terminal in association with the initial video.

Correlatively, the invention relates to a terminal comprising an adapter of an object for enriching a video, called initial video, and including a succession of images acquired by a camera, the adapter being able to adapt, at least in images following a first image of the initial video received by the terminal, at least one viewing characteristic for the enrichment object selected and inserted into the first image, the adapter being able to operate as a function of parameters of the position and calibration of said camera associated with the images of the initial video, the parameters having been received by the terminal in association with the initial video.

The characteristics and advantages of the enrichment method according to the invention presented below apply in the same way to the terminal according to the invention and vice versa.

The characteristics and advantages of the terminal and of the enrichment method according to the invention presented below apply in the same way to the server and to the processing method according to the invention and vice versa.

The first image is an image of the initial video chosen by a user of the terminal to insert the enrichment object therein. The adaptation of the viewing characteristics for the enrichment object according to the proposed enrichment method is performed as a function of parameters of the position and calibration of the camera associated with the first image, and of the parameters associated with the following images.

Following the implementation of the enrichment method according to the invention, the terminal obtains an enriched video from the initial video and from the enrichment object inserted into the first image and adapted in the following images.

Particularly, the terminal can insert several enrichment objects in the same first image. In one particular embodiment, the terminal inserts enrichment objects into different images, each of these images being considered as a first image within the meaning of the invention for the enrichment object inserted into this image.

The viewing characteristics for the enrichment object can include the size and/or the position of this enrichment object, or any other characteristic relating to a shooting of the enrichment object as if it were in the actual scene filmed by the camera. The position can be defined in particular by the distance, in an image of the video, between the enrichment object and a point representing a position of the camera; the enrichment object then being positioned on a circle of radius equal to said distance. The position can be defined by a viewing angle, by the camera, of the enrichment object, as if this object were filmed by the camera, the viewing angle being an angular coordinate defined relative to a point representing the position of the camera, for example 30 degrees northeast of the camera.

When the user inserts the enrichment object in the first image, an original position and orientation are determined in the scene relative to the position and orientation of the camera at the time of acquisition of this first image.

Then, the position and orientation of the enrichment object are adapted in the following images to give the illusion that this object is acquired by the camera according to the position and orientation of the camera associated with these following images.

The proposed technique offers a natural rendering because the dimensions (size), positions and viewing angles in the images of the enriched video are dynamically adapted as a function of the parameters of the camera at the time of acquisition of the images. The rendering is natural in that it gives the user the illusion that the enrichment objects have been acquired by the camera.

The proposed terminal can enrich the initial video substantially simultaneously with the receipt of the video and the parameters. Indeed, the terminal does not need to perform a complex processing of the content of the initial video to deduce the parameters of the camera.

The proposed technique allows a user of the terminal to enrich the video in a customized manner, by choosing the enrichment objects to be inserted into the first image. An enrichment object can be text or a still or moving image, of two or three dimensions. Thus, two terminals which receive the same initial video coming from the server, can obtain and restitute two differently enriched videos. In one particular embodiment, the terminal also inserts an enrichment sound object by adjusting it to the component of the soundtrack of the initial video associated with the first image.

In one particular embodiment, the terminal receives an enriched stream including the initial video and the parameters of the position and calibration of the camera associated with the images of the video. In this embodiment, the proposed terminal further comprises a communication module configured to receive the enriched stream composed of the initial video and of parameters of the position and calibration of the camera associated with the images of the initial video.

In one particular embodiment, the initial video is sent by the server as its images are acquired by the camera (real-time emission) and enriched in a customized manner by the terminal just before its live restitution.

In one particular embodiment, the server sends the parameters associated with the images of the initial video and the initial video in a desynchronized manner, that is to say before or after.

In another particular embodiment of the broadcast method, the server sends the parameters associated with an image and the image in a synchronized manner. Particularly, the parameters associated with the image can be sent in the header of a packet including this image. The server can send one said image and the parameters associated with this image on the same communication channel, or in a synchronized manner on separate channels. According to this embodiment, the proposed terminal receives the initial video and the parameters associated with at least one image synchronized with this image.

This embodiment allows the terminal to enrich the initial video as it is received. Indeed, thanks to synchronization, the terminal has the parameters of the camera corresponding to each image received from the initial video.

In one particular embodiment, the processing method according to the invention includes an insertion of the parameters of the position and calibration of the camera associated with the images of the initial video in the control data of the enriched stream.

The initial video is comprised in the payload of the enriched stream. It is recalled that according to the state of the art of the communication networks, when an emitter device wishes to send a message to a receiver device, it sends on the network the message with other data that allow the routing of the message to the receiver device. It is recalled that the payload are the part of the transmitted data that is the intended actual message (namely the initial video in our invention). The control data include headers and metadata that control the transmission of the payload.

Particularly, the proposed server can send the parameters of the camera in a “data” component associated with another “video” component used to broadcast the initial video.

Under this embodiment, insofar as the parameters of the camera are transmitted in an independent component, without any modification of the video components (images and sound), the server can send the initial video and the parameters of the camera for terminals in accordance with the invention and terminals of the state of the art, within the framework of the same broadcast. Only the receiver terminals in accordance with the invention and which wish to enrich the initial video take into consideration the parameters of the camera.

The parameters of the camera can also constitute metadata of the initial video images.

In one particular embodiment, the processing method further includes a step of inserting into the enriched stream at least one shooting parameter for at least one actual object of the scene filmed by said camera.

In one particular embodiment, the processing method further includes a step of sending, in association with the initial video, this shooting parameter for the actual object. This shooting parameter is defined, at the time of acquisition of one said image by the camera, in the Cartesian coordinate system in which the parameters of the position of the camera are defined.

In one particular embodiment of the enrichment method, the adaptation of the viewing characteristics for the enrichment object takes into account a shooting parameter for an actual object of the scene filmed by the camera, the shooting parameter for the actual object being received by the terminal in association with the initial video.

The shooting parameter for the actual object includes the position of the actual object relative to the camera, the position being defined for example in terms of distance and/or frontal or lateral viewing angle relative to a point representing a position of the camera.

These embodiments make it possible to take into account the positions of the actual objects filmed relative to the aforementioned coordinate system, particularly to take into account the displacement of the actual objects relative to this coordinate system. This allows continuous and dynamic adaptation of the parameters of the enrichment objects according to changes in the content of the initial video. It is noted that the camera and the actual object can both be moving.

In one particular embodiment, the enrichment method further includes a step of recording in a non-volatile memory accessible by the terminal, the initial video or the enriched video, the parameters of the position and calibration of the camera, and possibly shooting parameters for the actual object.

This embodiment allows the terminal to subsequently enrich the recorded video by referring to the parameters of the camera (and possibly the shooting parameters for the filmed actual object), to obtain a new enriched video.

The recording of the initial or enriched video allows for different enrichment each time. Indeed, the inserted enrichment objects, their view characteristics such as their sizes and positions, and the first images into which the objects are inserted can be different.

In one particular embodiment, the processing method comprises an optimization of an emission of the parameters of the position and calibration of the camera associated with the images of the initial video.

In one particular embodiment, the processing method includes an insertion into the enriched stream of at least one parameter associated with a given image of the initial video, if and only if this parameter is different from the corresponding parameter associated with the previous image. This embodiment makes it possible to insert optimized parameters into the enriched stream and therefore to reduce the resources (bandwidth, energy consumption) necessary for the transmission of this stream.

This embodiment allows an optimization of the parameters to be sent by the server to the terminals. Indeed, according to this embodiment, the server only sends the changes of the parameters of the camera, for example a change of the position of the camera, a change of a shooting angle by the camera and/or a change of the focal length of the camera (zoom in or zoom out). This embodiment makes it possible to optimize the use of the bandwidth between the server and the terminals, and to reduce the energy consumption of the terminals.

In one particular embodiment, the processing method includes an insertion into the enriched stream of information on a variation of a parameter associated with a given image of the initial video, if the sending of said information consumes less bandwidth than the sending of the new parameter after said variation.

In one particular embodiment of the processing method according to the invention, an emission of the parameters of the position and calibration of the camera associated with the images of the initial video in the control data of the enriched stream is repeated. Particularly, the emission of the parameters can be repeated on a regular basis, for example every 15 or 30 minutes. Alternatively, the emission of the parameters can be repeated at predefined times.

The fact of reemitting the parameters allows each terminal which accesses a current broadcast of the initial video to recover the parameters of the camera and thus be able to perform the enrichment by taking into account these parameters. This embodiment allows the terminal to receive the parameters of the camera even if the camera has not moved. Indeed, the sending of the parameters is not performed only after a change of one of these parameters.

In one particular embodiment, the processing method includes the fact of obtaining by the server at least two initial videos acquired by two cameras and which correspond to the same filmed scene. The proposed server sends to the terminal the two initial videos and the parameters associated with the images of each of the two videos.

In one particular embodiment, the enrichment method includes a receipt of at least two initial videos acquired by two cameras and corresponding to the same filmed scene, and parameters of these cameras. The insertion of the enrichment object and the adaptation of its view characteristics take into account the parameters of each of the cameras.

According to this embodiment, the enriched video is obtained from the two initial videos.

Particularly, the enriched video can be obtained by a selection, at a given time, of the video to be enriched from among the initial videos. The enriched video sometimes corresponds to the first initial enriched video, and sometimes to the second initial enriched video.

Alternatively, the enriched video can be obtained by a combination of the two initial videos, for example by stereoscopy, followed by an insertion of an enrichment object with a two-dimensional or three-dimensional effect and an adaptation of the characteristics of this object.

The enriched video according to the method of the invention can be a video called augmented reality video, that is to say obtained by superimposition of an initial video representing an actual scene and of enrichment objects calculated by the terminal at the time of receipt of the initial video.

The invention also relates to a video broadcasting system, the system comprising at least one camera, a server in accordance with the invention and at least one terminal in accordance with the invention.

The invention also relates to a device for acquiring the initial video for its broadcast, this device comprising an enriched stream generator, the enriched stream being composed of the initial video and, for at least one image of the initial video, of parameters of the position and calibration of the camera associated with this image, the initial video and the parameters being able to be emitted to at least one terminal. This device can be connected to a recorder connectable to an emitter, for example the proposed server. Alternatively, this device can be connected directly to an emitter such as the proposed server.

The invention also relates to a computer program on a recording medium, this program being capable of being implemented in a computer or a server in accordance with the invention. This program includes instructions adapted to the implementation of a processing method, as described above.

The invention also relates to a computer program on a recording medium, this program being capable of being implemented in a computer or a terminal in accordance with the invention. This program includes instructions adapted to the implementation of an enrichment method, as described above.

Each of these programs may use any programming language, and be in the form of source code, object code or intermediate code between source code and object code, such as in partially compiled form, or in any other desirable form.

The invention also relates to an information medium or a recording medium readable by a computer, and including instructions from a computer program as mentioned above.

The information or recording media can be any entity or device capable of storing the programs. For example, the media can include a storage medium, such as a ROM, for example a CD ROM or a microelectronic circuit ROM or a magnetic recording medium, for example a floppy disk or a hard disk or a flash memory.

On the other hand, the information or recording media can be transmissible media such as an electrical or optical signal, which can be routed via an electrical or optical cable, by radio link, by wireless optical link or by other means.

The programs according to the invention can be particularly downloaded from an Internet-type network.

Alternatively, each information or recording medium can be an integrated circuit in which the program is incorporated, the circuit being adapted to execute or to be used in the execution of a method in accordance with the invention.

### BRIEF DESCRIPTION OF THE DRAWINGS

Other characteristics and advantages of the present invention will emerge from the description given below, with reference to the appended drawings which illustrate an exemplary embodiment devoid of any limitation. In the figures:

FIG. 1 is a flowchart representing steps of the proposed methods, implemented according to a first particular embodiment;

FIG. 2 is a flowchart representing steps of the proposed methods, implemented according to another particular embodiment;

FIG. 3 illustrates functional architectures of a server and of proposed terminals, according to one particular embodiment;

FIG. 4 presents a hardware architecture of a proposed terminal, according to one particular embodiment; and

FIG. 5 presents a hardware architecture of a proposed server, according to one particular embodiment.

### DESCRIPTION OF THE EMBODIMENTS

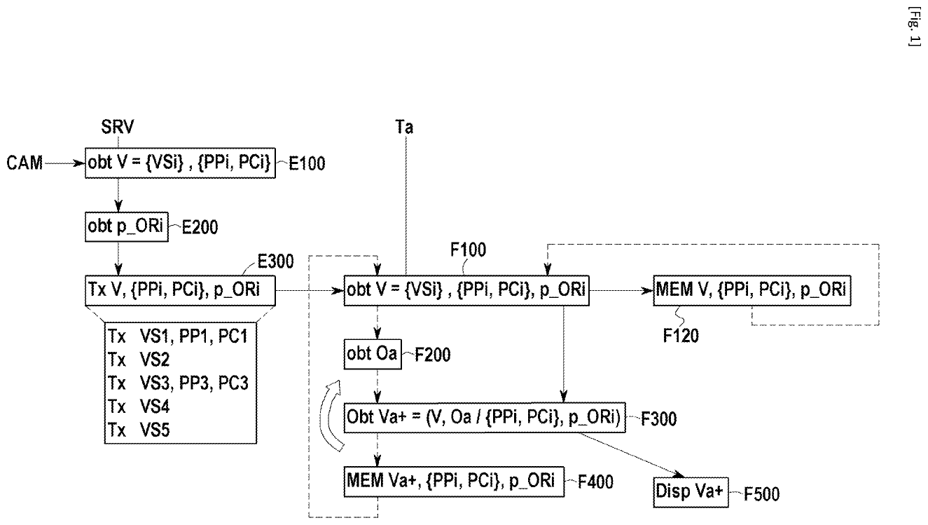

FIG. 1 is a flowchart representing:
steps, numbered Exxx, of a method for processing a video for broadcast, implemented according to one particular embodiment by a server SRV; and
steps, numbered Fxxx, of a method for enriching a video, implemented according to one particular embodiment by a terminal Ta; the server SRV, the terminal Ta and the methods being in accordance with the invention.

A camera CAM is connected to the server SRV, for example via a wired connection. No limitation is imposed on the nature of the connection of the camera to the server.

The server SRV and the terminal Ta can communicate with each other via a communication network, for example a television broadcasting network or an IP network. No limitation is imposed on the nature of this communication network.

During a step E100, the server SRV obtains a video, called initial video V, acquired by the camera CAM. In the embodiment described here, the server SRV obtains the video V as it is acquired by the camera CAM. The server SRV is configured to broadcast this video live, as it is acquired.

The initial video V is a sequence of several images VSi. Parameters of the position PPi and calibration PCi of the camera correspond to each image VSi when this image VSi was acquired. The parameters of the position PPi include for example coordinates of the camera in a Cartesian coordinate system. The parameters of the calibration PCi of the camera include for example the focal length, a coordinate of the optical center and the distortion parameters of the camera CAM.

During step E100, the server SRV obtains the images VSi and the parameters PPi, PCi of the camera associated with these images VSi. In the embodiment described here, the server SRV obtains the parameters PPi and PCi synchronous with the associated images VSi.

In the embodiment described here, and during an optional step E200, the server SRV obtains at least one shooting parameter p_ORi for an actual object of the scene filmed by the camera CAM in the Cartesian coordinate system at the time of acquisition of the image VSi. The shooting parameter p_ORi can correspond to a position and/or to a frontal or lateral viewing angle of the actual object relative to the camera. The actual object can be still or moving.

During a step E300, the server SRV sends to the terminal Ta the initial video V as it is acquired and the parameters PPi and PCi associated with the images VSi of the initial video V.

In the example described here, it is assumed that the initial video V includes images VS1 to VSS. The first image VS1 is acquired by the camera CAM whose parameters, during the acquisition, are referenced by PP1 and PC1. The server SRV sends during step E300 the image VS1 in association with the parameters PP1 and PC1. These position and calibration parameters PP1 and PC1 are not changed during the acquisition of the second image VS2. To optimize the bandwidth, the server SRV sends during step E300, the image VS2 without returning the parameters PP1 and PC1, these parameters not being changed and also being associated with the image VS2. Assuming that the third image VS3 corresponds to new parameters of the camera, PP3 and PC3, the server SRV sends during step E300 the image VS3 in association with the new parameters PP3 and PC3.

In the embodiment described here, the server SRV only sends the parameters PPi and PCi when these parameters are different from the last parameters sent. Particularly, in the event of evolution of some parameters, the server can send information on the evolution of these parameters (for example the variations), if this allows better optimization of the bandwidth compared to a sending of new parameters. In another embodiment, the server SRV sends the parameters PPi and PCi associated with each image VSi, even if they are also associated with the previous image VS(i−1).

The server SRV sends (E300) the parameters PPi and PCi synchronously with the associated images VSi, but on a different communication channel.

The server SRV also sends during step E300, the shooting parameter p_ORi for the actual object of the scene filmed by the camera, at the time of acquisition of the image VSi. This parameter is sent in association with the corresponding image VSi. If the actual object changes position, the server SRV sends a new shooting parameter in association with the new corresponding image.

During a step F100 of the enrichment method, the terminal Ta receives the initial video V from the server SRV, as well as the position PPi and calibration PCi parameters of the camera CAM during the acquisition of the images VSi.

In the embodiment described here, as the server has sent (E300) the shooting parameter p_ORi for the actual object filmed by the camera CAM, the terminal Ta receives this parameter p_ORi during step F100.

During a step F200, the terminal Ta obtains at least one enrichment object Oa, such as text, or a still or moving image. The terminal Ta can select the object Oa from a library, for example recorded in a memory of the terminal Ta or in a memory of another device to which the terminal can access. The selection by the terminal of the object is made in particular as a function of one or more parameters for visualizing the enriched video, in particular from among the following: visualization context (time of the day, place, number of viewers, etc.), profile of the user, parameters relating to the terminal of the user (size of the screen, quality of the image and/or of the sound that can be restituted, etc.), etc. Alternatively, the terminal Ta can receive the enrichment object Oa from the server SRV. A user of the terminal Ta selects the object Oa to insert it into an image of the initial video V, called “first image”.

During a step F300 of obtaining an enriched video Va+ from the video V, following the selection of the enrichment object Oa, the terminal Ta inserts this selected object into the first image, for example the image VS1.

In one embodiment, the terminal Ta obtains during step F200 a sound-type enrichment object, that it inserts during step F300 by synchronizing it with the sound component associated with the first image VS1.

As the initial video V is broadcast live, the terminal Ta continues to receive (F100) images VSi of this video V, and adapts during step F300 of obtaining the enriched video Va+, viewing characteristics for the enrichment object Oa as a function of the parameters PP1 and PC1 associated with the first image VS1, and of the parameters PPi and PCi associated with each of the following images VSi, i varies from 2 to 5 in our example. The viewing characteristics for the enrichment object include for example the position and/or the size of this object in an image VSi.

According to the example described here, as the parameters PP3 and PC3 associated with the image VS3 are different from those associated with the image VS2, the view characteristics such as the size and position of the enrichment object Oa in the third image VS3 are modified compared to the viewing characteristics for the enrichment object Oa in the second image VS2.

According to an example of use of the methods of the invention, the initial video comprises an acquisition of a scene in a room, for example in a living room. The terminal inserts during a first iteration of step F300, an enrichment object Oa representing a clock or a decorative painting, to decorate a wall in the living room. The viewing characteristics (position and size) of this clock or table Oa inserted into the first image VS1 are selected by the user to match the position and dimensions of the wall in the scene. The terminal Ta records the parameters of the camera associated with the first image VS1 and the parameters of the object Oa inserted into the first image VS1, such as its size, its position and its orientation.

Assuming that in a subsequent image VSn of the initial video V, the parameters of the camera CAM change, for example by enlarging the focal length of the camera (zoom), but that the position of the optical center of the camera did not vary since the acquisition position of VS1. Under these conditions, the position and orientation of the object in the image VSn are identical to what they were in the image VS1 but the size of the object Oa is enlarged during an iteration of the step F300. The new size of the object Oa in the image VSn is determined from the size of the object Oa in the image VS1, the change of the focal length of the camera between the images VS1 and VSn, and the position of the object Oa in the image VS1 relative to the position of the optical center of the camera associated with the image VS1.

Assuming that in another following image VSm, the parameters of the camera CAM change, for example by a rotation of the camera, the position of the object Oa in the image VSm is adapted during an iteration of step F300. The new position of the enrichment object Oa is determined from its position in the previous image VSn and the values of the parameter of the camera that has changed (in particular the coordinates of the optical center), before and after the change.

In accordance with the invention, the adaptation of the position, orientation and size (including the depth) of the object Oa in the images VSn, VSm are such that the object is perceived as if it had been acquired in the actual scene by the camera, knowing that the position, orientation and size of the object Oa in the actual scene are defined by the position, orientation and size of the object Oa in the image VS1 at the time of its insertion.

According to another example of use of the methods of the invention, the initial video V is related to a football match. On the first image, the enrichment object Oa inserted is a texture covering the image of the balloon illustrated by the first figure. As the position p_ORi of the actual ball changes relative to the camera, the size and position of the image portion covered by the texture Oa are adapted during the iterations of step F300.

During a step F500, the terminal T restitutes the enriched video Va+, for example on a screen of the terminal Ta. In the described embodiment, the restitution F500 is implemented as the viewing characteristics for the object Oa are adapted and the enriched video Va+ is obtained F300. Alternatively, the restitution can take place after the enrichment of all the images VSi of the initial video V is finished.

During an optional step F120, the terminal Ta records in a memory accessible by the latter, the initial video V, the parameters PPi and PCi associated with the images VSi of the initial video V, and possibly the shooting parameter p_ORi for the actual object relative to the camera CAM. This recording allows subsequent enrichment of the initial video V. The rendering of this subsequent enrichment may be different from the enriched video Va+.

During an optional step F400, the terminal Ta records in a memory accessible by the latter, the enriched video Va+, the parameters PPi and PCi associated with the images VSi of the initial video V, and possibly the shooting parameter p_ORi for the actual object relative to the camera CAM. This recording allows subsequent complementary enrichment from the already enriched video Va+.

In the embodiment described with reference to [FIG. 1], the server sends the parameters PPi and PCi associated with the images VSi, in synchronization with the sending of the images VSi. In another embodiment, the parameters and the images are sent with a time shift, one before the other, with cross-references (at least one reference from a parameter to an image and at least one reference from an image to a parameter) in order to recreate the synchronization at the level of the terminal.

In one particular embodiment, the terminal includes two modes of restitution of the received video: a mode of restitution of the initial video and an enriched mode of restitution. The enriched mode of restitution includes the implementation of steps F200 to F500 whereas the mode of restitution of the initial video includes directly after step of receiving F100 the enriched stream the restitution of the initial video carried by this enriched stream. The mode of restitution implemented depends on an action by the user. In particular, the enriched mode of restitution is triggered by a request for enrichment received by the terminal in particular by means of a user interface.

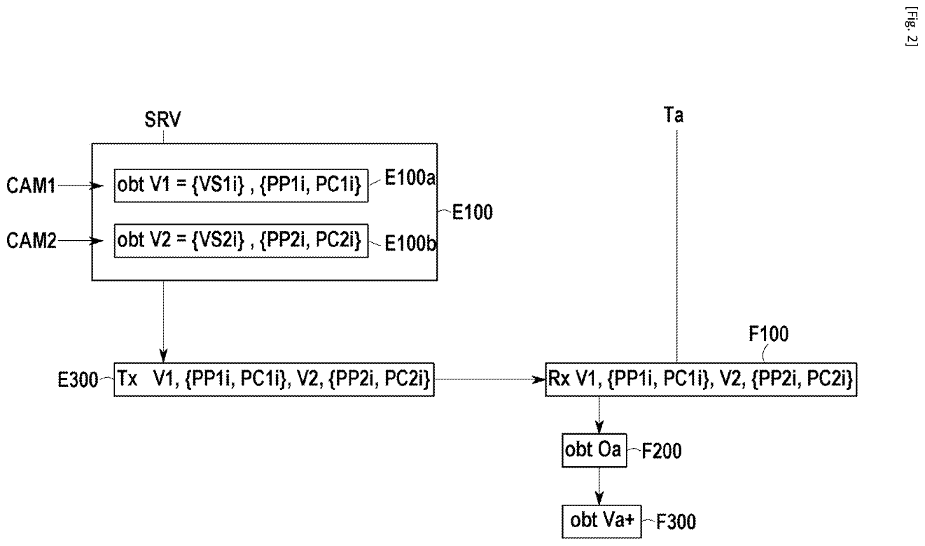

FIG. 2 is a flowchart representing steps Exxx of the method for processing a video, and steps Fxxx of the method for enriching a video, the methods being implemented according to a second particular embodiment.

In the embodiment described here, and contrary to the first embodiment described with reference to [FIG. 1], the server SRV obtains during steps E100a and E100b, two initial videos V1 and V2 acquired by two cameras CAM1 and CAM2 to film the same scene, simultaneously. These videos are synchronized. During these steps E100a and E100b, the server SRV obtains parameters of the position PP1i and calibration PC1i of the camera CAM1, associated with the images of the first video V1, and parameters of the position PP2i and calibration PC2i of the camera CAM2, associated with the images of the second video V2.

During a step E300 similar to step E300 described with reference to [FIG. 1], the server SRV sends the two initial videos V1 and V2 and the set of parameters to the terminal Ta.

During a step F100 similar to step F100 described with reference to [FIG. 1], the terminal Ta receives the two initial videos V1 and V2 and the set of parameters coming from the server SRV.

During a step F200 similar to step F200 described with reference to [FIG. 1], the terminal Ta obtains the enrichment object Oa, for example a three-dimensional modeled object.

During a step F300, the terminal Ta obtains an enriched video Va+ from the two initial videos V1 and V2, for example by combining images of the two videos to have a video with a 3D effect, then by inserting the object Oa and by adapting its view characteristics (position, size, orientation, etc.) while taking into account the parameters associated with the images of the first video V1 and the parameters associated with the images of the first video V2.

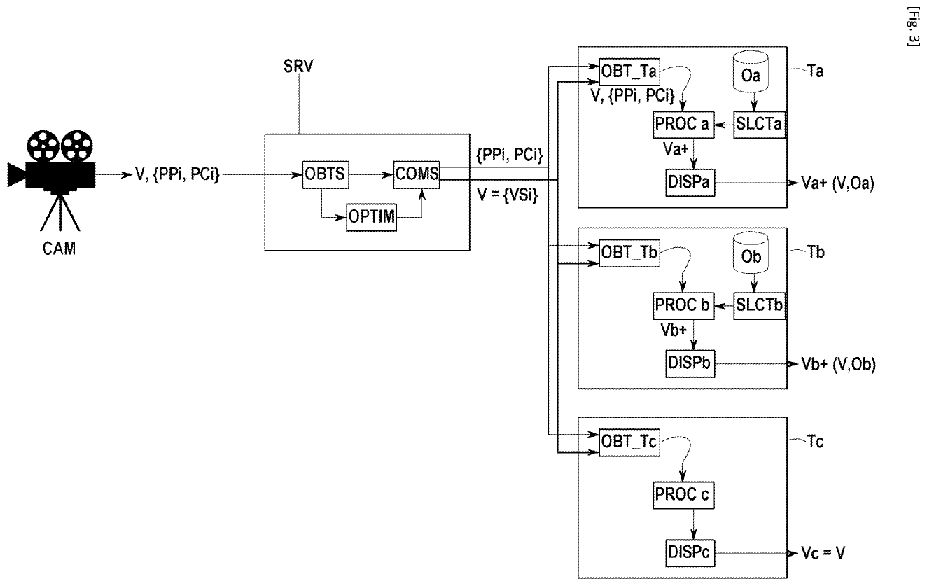

FIG. 3 represents functional architectures, according to one particular embodiment, of the proposed server SRV, of the terminal Ta and of two other terminals Tb and Tc in accordance with the invention.

The camera CAM described with reference to [FIG. 1] is connected to the server SRV. The server SRV, the terminals Ta, Tb and Tc and the camera CAM form a system for broadcasting a video V.

The server SRV includes:
a module OBTS for obtaining (E100) the initial video V and obtaining (E100), for at least one image VSi of the initial video V, the parameters PPi, PCi of the position and calibration of the camera CAM associated with this image VSi; this module OBTS is an enriched stream generator, the enriched stream being composed of said initial video V and, for at least one image VSi of the initial video V, of parameters PPi, PCi of the position and calibration of the camera associated with this image and
a communication module COMS configured to send (E300) the initial video V and the parameters PPi, PCi to the terminals Ta, Tb and Tc.

The module OBTS can further be configured to obtain (E200) the shooting parameters p_ORi for the actual objects filmed by the camera CAM. The communication module CMS is further configured to send these parameters p_ORi in association with the corresponding images of the initial video V.

In the embodiment described here, the server SRV further comprises an optimization module OPTIM configured to optimize the emission of the parameters of the camera PPi and PCi. For example, the module OPTIM can be configured to determine whether the parameters PPi and PCi associated with an image VSi are different from the parameters associated with the previous image VS (i−1). The optimization module OPTIM controls the communication module COM_S so that the latter sends (E300) the parameters associated with the image VSi if and only if these parameters are different from those associated with the image VS(i−1). According to another example, the optimization module OPTIM is configured to determine whether the sending of new parameters of the camera associated with the image VSi or the sending of the variations between the parameters associated with the images VSi and VS(i−1) requires fewer resources in terms of bandwidth and to control the communications module according to a result of this comparison.

In the embodiment described here, and as illustrated by [FIG. 3], the server SRV sends the parameters on a communication channel different from the channel used to send the video V. Alternatively, the parameters and the images VSi of the video V can be sent over the same communication channel, the parameters being sent as control data, for example in packet headers, while the images being sent as payload, in the bodies of the packets.

The terminal Ta includes:
a communication module OBT_Ta configured to receive (F100) the initial video V, this initial video comprising a succession of images VSi acquired by the camera CAM, the communication module is further configured to receive (F100) the parameters PPi, PCi of the position and calibration of the camera associated with at least one image VSi of the initial video V;
a selector SLCTa configured to select (F200) at least one enrichment object Oa; and
an adapter PROCa configured to obtain (F300) an enriched video Va+ by:
   insertion of the enrichment object Oa selected in a first image VS1 of the initial video V; and
   adaptation of at least one viewing characteristic for the enrichment object Oa in the following images (VS2 to VS5) as a function of the parameters PP1, PC1 associated with the first image and of the parameters PPi, PCi associated with each of the following images VSi of the initial video V.

In the embodiment described here, the terminal Ta further includes a module DISPa for restituting (F500) the enriched video Va+.

The terminal Ta can comprise a memory in which a library is recorded, the enrichment object Oa is obtained from this library.

The terminal Tb has a functional architecture similar to that of the terminal Ta. The terminal Tb obtains (F200) an enrichment object Ob different from the object Oa. The terminal Tb then obtains (F300), from the same initial video V, an enriched video Vb+ different from the video Va+ enriched by the terminal Ta. It is noted that even if the objects Oa and Ob are identical, the enriched videos Oa and Ob can be different because the choice of the users of the terminals Ta and Tb, in terms of the time of insertion of the objects Oa and Ob (and therefore of the “first image”), and of the viewing characteristics (for example the position and the size) for the enrichment objects during the initial insertion, may be different.

The terminal Tc also has a functional architecture similar to that of the terminal Ta. Assuming that the terminal Tc does not wish to enrich the initial video V, it then restitutes a video Vc identical to the initial video V. The implementation of the processing method by the server SRV has no impact on the operation of the terminal Tc. Indeed, the video V and the parameters PPi and PCi of the camera are sent on two different channels. The terminal Tc can ignore the parameter transmission channel.

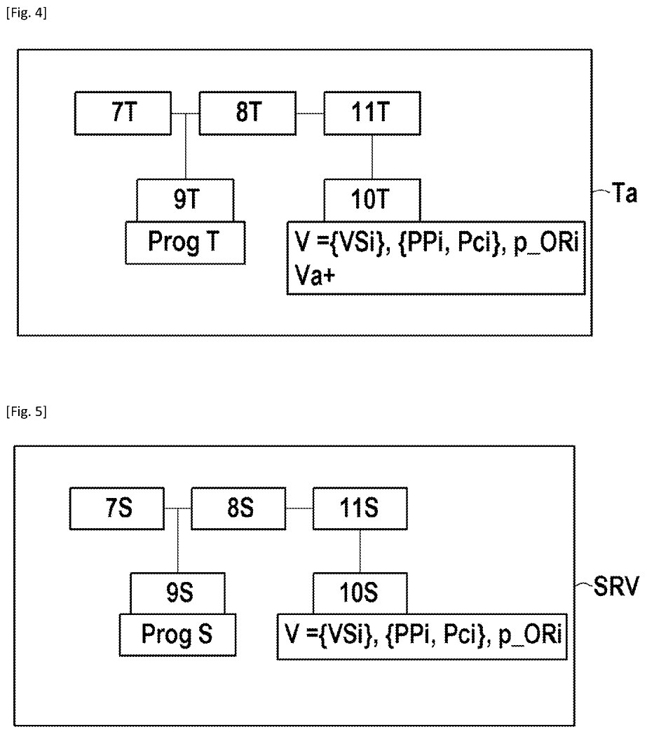

In the embodiments described here, each of the terminals Ta and Tb has the hardware architecture of a computer, as illustrated in [FIG. 4].

The architecture of the terminal Ta for example comprises in particular a processor 7T, a random access memory 8T, a read only memory 9T, a non-volatile flash memory 10T in one particular embodiment of the invention, as well as communication means 11T. Such means are known per se and are not described in more detail here.

The read only memory 9T of the terminal Ta constitutes a recording medium in accordance with the invention, readable by the processor 7T and on which a computer program ProgT in accordance with the invention is recorded here.

The memory 10T of the terminal Ta makes it possible to record variables used for the execution of the steps of the method proposed to enrich a video, such as the initial video V, the images VSi, the parameters PPi and PCi of the position and calibration of the camera, the shooting parameter p_ORi for the actual object, and the enriched video Va+.

The computer program ProgT defines functional and software modules here, configured to enrich the initial video V by the terminal Ta. These functional modules rely on and/or control the hardware elements 7T-11T of the terminal Ta mentioned above.

In the embodiments described here, the server SRV has the hardware architecture of a computer, as illustrated in [FIG. 5].

The architecture of the server SRV comprises in particular a processor 7S, a random access memory 8S, a read only memory 9S, a non-volatile flash memory 10S in one particular embodiment of the invention, as well as communication means 11S. Such means are known per se and are not described in more detail here.

The read only memory 9S of the server SRV constitutes a recording medium in accordance with the invention, readable by the processor 7S and on which a computer program ProgS in accordance with the invention is recorded here.

The memory 10S of the server SRV makes it possible to record variables used for the execution of the steps of the proposed method for processing a video, such as the initial video V, the images VSi, the parameters PPi and PCi of the position and calibration of the camera, and the shooting parameter p_ORi for the actual object.

The computer program ProgS defines functional and software modules here, configured to broadcast the initial video V by the server SRV. These functional modules rely on and/or control the hardware elements 7S-11S of the server SRV mentioned above.

1. A method for enriching an initial video with at least one enrichment object, said initial video including a succession of images acquired by a camera, the method implemented by a terminal and comprising at least:
adaptating, at least in images following a first image of said initial video received by the terminal, viewing characteristics for one said enrichment object selected and inserted into said first image, the adaptation being performed as a function of parameters of said camera associated with the images of the initial video, the parameters having been received by the terminal in association with the initial video.

2. The method claim 1, wherein the adaptation of the viewing characteristics for the enrichment object takes into account a shooting parameter for an actual object of a scene filmed by said camera, the shooting parameter for the actual object being received by the terminal in association with the initial video.

3. A method for processing an initial video for broadcast, the initial video including a succession of images acquired by a camera, said method being implemented by a server and comprising at least:
generating an enriched stream, the enriched stream being composed of the initial video and, for at least one image of the initial video, of parameters of said camera associated with this image, said initial video (V) and said parameters being able to be emitted to at least one terminal.

4. The method of claim 3, further comprising an insertion of position and calibration parameters of said camera associated with the images of the initial video in the control data of the enriched stream.

5. The method of claim 3, wherein said initial video is sent as it is acquired.

6. The method of claim 3, wherein a given image and the parameters associated with that image are synchronized in the enriched stream.

7. The method of claim 3, further comprising an optimization of an emission of the parameters of said camera associated with the images of the initial video.

8. The method of claim 7, further comprising an insertion into the enriched stream of at least one said parameter associated with a given image of the initial video, if and only if this parameter is different from a corresponding parameter associated with the previous image.

9. The method of claim 3, further comprising a step of inserting into the enriched stream a shooting parameter for an actual object of the scene filmed by said camera.

10. The method of claim 3, wherein an emission of position and calibration parameters of said camera associated with the images of the initial video in the control data of the enriched stream is repeated.

11. A non-transitory computer readable medium having stored thereon instructions which, when executed by a processor, cause the processor to implement the method of claim 1.

12. A non-transitory computer-readable medium having stored thereon instructions which, when executed by a processor, cause the processor to implement the method of claim 3.

13. A terminal comprising an adapter of an object for enriching an initial video including a succession of images acquired by a camera, the adapter being able to adapt, at least in images following a first image of the initial video received by the terminal, at least one viewing characteristic for the enrichment object selected and inserted into the first image, the adapter being able to operate as a function of parameters of said camera associated with the images of the initial video, the parameters having been received by the terminal in association with the initial video.

14. The terminal of claim 13, further comprising a communication module configured to receive an enriched stream composed of the initial video and of said parameters associated with the images of the initial video.

15. A server configured to process an initial video for broadcast, the initial video including a succession of images acquired by a camera, the server comprising an enriched stream generator, the enriched stream being composed of said initial video and, for at least one image of the initial video, of parameters of said camera associated with this image, the initial video and said parameters being able to be emitted to at least one terminal.
